(19) United States
(12) Patent Application Publication
(10) Pub. No.: US 2004/0255747 A1
(43) Pub. Date: Dec. 23, 2004

(54) Device for cross-cutting webs of fabric, especially paper or cardboard

(76) Inventor: Albert Stitz, Kurten (DE)

Correspondence Address: Marshall Gerstein & Borun, 6300 Sears Tower, 233 South Wacker Drive, Chicago, IL, 60606-6357, US

(21) Appl. No.: 10/487,175

(22) PCT Filed: Jul. 26, 2002
(86) PCT No.: PCT/EP02/08315

(51) Int. Cl. B26D 7/06

(52) U.S. Cl. 83/401; 83/436.3; 83/469

(57) ABSTRACT

Devices for cross-cutting paper or cardboard containing a cross-cutting device with two cutting drums which are equipped with cross cutters are already known per se. A sheet transport device is arranged behind the cross-cutting device, containing a braking device with a braking cylinder. In order to prevent marks on delicate paper or types of cardboard on said sheets, the inventive braking cylinder comprises a cylindrical base body which is secured to the blade-type elements, said blade-type elements being made of an elastic material and protruding in a radial manner with ample distance between each other, ending in a cylindrical enveloping surface which is coaxial in relation to the base body.

### TECHNICAL FIELD

The invention relates to a device for crosscutting webs of material, especially webs of paper or cardboard, having a crosscutting means comprising two blade drums fitted with transverse blades and having a sheet transport means that is positioned downstream from the crosscutting means and that has a braking means with a braking roller.

### STATE OF THE ART

Crosscutting devices that crosscut a web of paper or cardboard in order to make individual sheets that are subsequently placed on a stack are known to have a sheet transport means that is positioned downstream from the crosscutting means and that has a braking means with a braking roller. When a sheet is braked, the front edge of the following sheet, which has not yet been braked, slides over the rear edge of the braked sheet. This creates a stream of overlapping sheets that is subsequently stacked in a stacking means. A crosscutting means of this generic type is described in German patent DE 19945114.

With the known braking means, a fast-running sheet is braked when the braking roller presses it down onto the leading and thus already braked and slower sheet. Due to this relative movement between the two sheets during the braking process, markings are created on the surface if the slower sheet of the paper or cardboard is of a delicate type.

### DESCRIPTION OF THE INVENTION

Therefore, the invention is based on the objective of improving a crosscutting device of the generic type in such a way that markings on the sheets are avoided, even in the case of delicate types of paper or cardboard.

This objective is achieved in that the braking roller consists of a cylindrical basic element on which radially projecting lamellae made of an elastic material are attached along the circumference at intervals from each other, said lamellae ending in a cylindrical enveloping surface that is coaxial to the basic element.

Owing to the configuration of the braking roller with radially projecting lamellae, the sheet is braked in that its kinetic energy is largely transferred to a lamella. The elastic lamellae deflect towards the back and yield, whereby the deflection distance is the braking distance of the sheet. In this process, as a result of the sheet pressing against a lamella, the effective circumferential speed of the braking roller adapts almost completely to the conveying speed of the slower sheet. Only after the faster sheet has been virtually braked is it pressed against the preceding sheet.

The subclaims contain embodiments of a braking roller according to the invention that are preferred since they are especially advantageous.

### BRIEF DESCRIPTION OF THE DRAWING

The drawing serves to explain the invention with reference to an embodiment depicted in a simplified manner.

The following is shown:

FIG. 1—the side view of a crosscutting device,

FIG. 2—an enlarged section of the braking means with the braking roller,

FIG. 3—a cross section through the braking roller.

### WAYS TO EXECUTE THE INVENTION

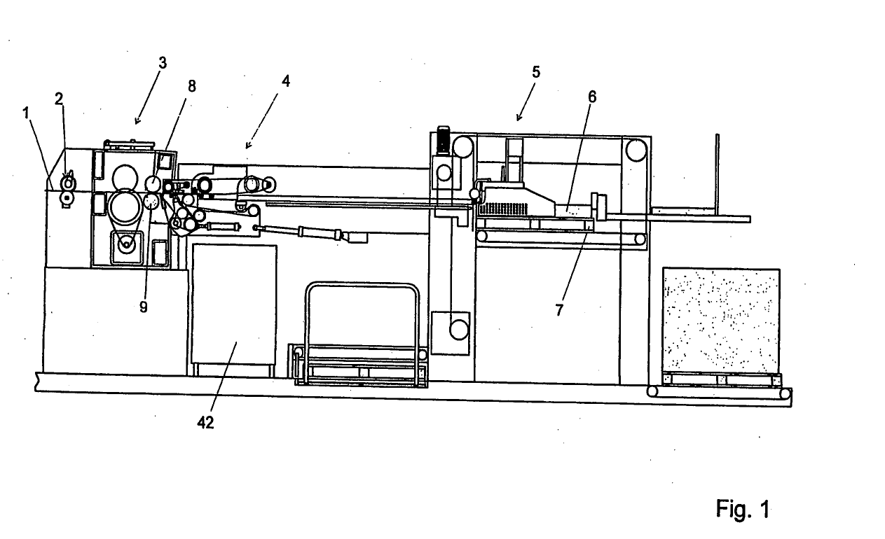

The device shown in a general view in FIG. 1 serves to make sheets of paper or cardboard from a continuously fed web 1. In the web/sheet travel direction (in the figures from the left to the right), the following components are arranged consecutively:

A lengthwise cutting means 2 in which the edges of the web 1 are cut and optionally the web 1 is divided into up to six individual webs, a crosscutting means 3, a sheet transport means 4, by which the sheets made during the crosscutting are taken over and braked, whereby a stream of overlapping sheets is formed, and a stacking means 5 in which the sheets are placed onto stacks 6 that rest on pallets.

In a known manner, the crosscutting means 3 comprises two blade drums 8, 9 arranged one above the other, that are usually fitted with one transverse blade by means of which the web 1 is cut as the sheets run through.

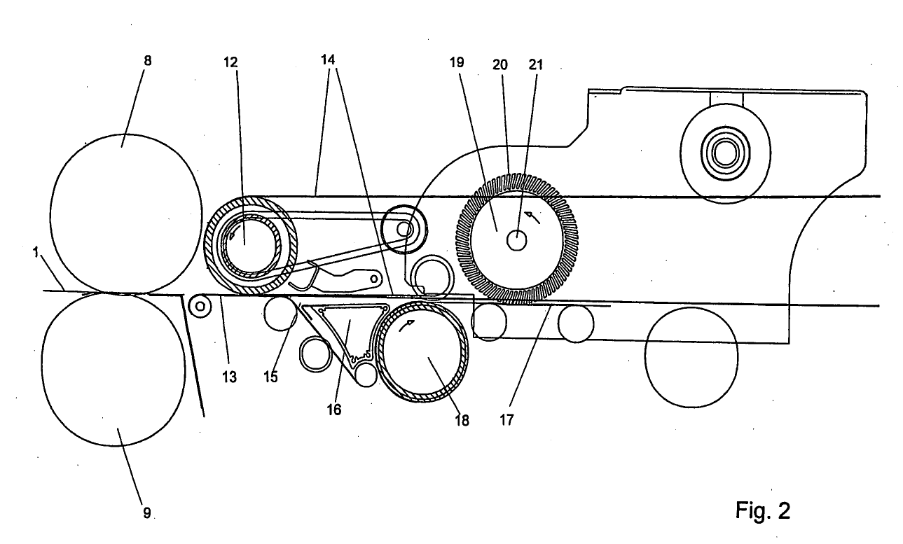

The sheet transport means 4 is located directly behind the crosscutting means 3 and it is shown in an enlarged view in FIG. 2. It comprises elements to take over the beginning of the web generated by the crosscutting and to hold the web taut during the crosscutting, to accelerate the further transport of the sheet made by a crosscut in order to create a gap between two sheets, and to brake a sheet so as to form a stream of overlapping sheets that is fed to the stacking means 5 at a decelerated transport speed.

The sheet transport means 4 starts with an upper catching roller 12 and an associated fast lower conveyor belt 13. The catching roller 12 is at the same time the deflection roller on the inlet side of a rapidly rotating upper conveyor belt 14 that is made up of individual parallel belts and that is driven at a higher speed than the speed of the incoming web 1. Together with the catching roller 12, the lower conveyor belt 13 forms a nip with which the beginning of an incoming web is taken over. The conveyor belt 13 is driven at the elevated speed of the upper conveyor belt 14. Thus, a sheet made by the crosscutting is further transported at an elevated speed.

Downstream from a sheet lock 15, the braking and overlapping means begins with a suction box 16 that is kept under negative pressure and whose upper wall, fitted with suction openings, runs parallel below the conveying plane at a slight distance. The negative pressure sucks in the rear edge of the sheets and deflects them downwards. Next in line is a lower conveyor belt 17 that runs at the slower stacking speed at which the sheets are placed onto the stack 6. When a sheet is braked, the front edge of the following sheet that is traveling faster slides over the rear edge of the braked sheet. This forms a stream of overlapping sheets that is conveyed further on the lower conveyor belt 17 at the slower stacking speed.

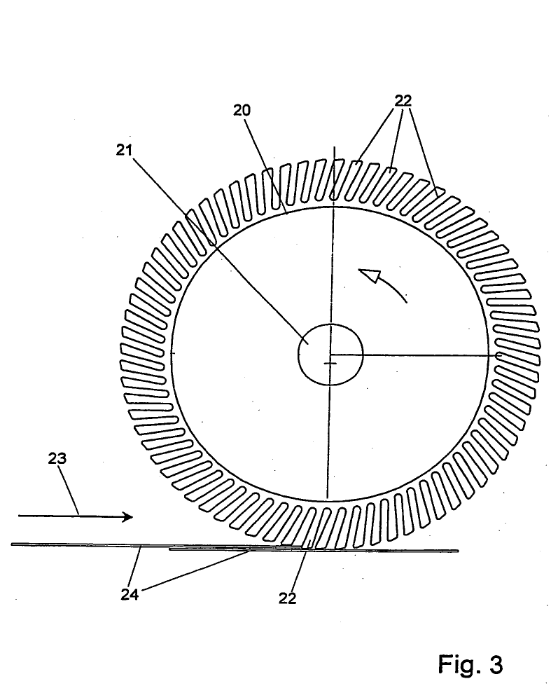

In order to press the fast-traveling sheets from the fast-running upper conveyor belts 14 downwards onto the slow conveyer belt 17 while braking the sheets in the process, behind the inlet-side deflection roller 18 of the lower conveyor belt 13 between the upper belts 14, there are projecting, rotating braking rollers 19 that are facing downwards along the circumference on a shared axis 21. FIG. 3 shows an enlarged cross section of a braking roller 19.

Each braking roller 20 consists of a cylindrical basic element 20 that is mounted on the shared rotating axis 21. Radially projecting lamellae 22 made of an elastic material are attached to the basic element 20, said lamellae 22 being at a distance from each other and ending in a cylindrical enveloping surface that is coaxial with respect to the basic element 20. Preferably, the lamellae 22 are made in such a way that axial slits are cut along the circumference of a hollow cylinder made of elastic material. In the present embodiment, the hollow cylinder has an outer diameter of about 220 mm and slits with a depth of about 20 mm are made.

Preferably, the lamellae 22 are tilted slightly counter to the travel direction 23 of the sheets 24, as can be seen in FIG. 3. In the embodiment, the angle of tilt is about 20° relative to the radial. The ends of the lamellae 22 are undercut in such a way that their end surface essentially constitutes a shared cylindrical enveloping surface.

The lamellae 22 are made of an elastic and highly wear-resistant material. Preferably they are made of a cellular plastic material with a large number of pores, which is not only elastic but also somewhat volume-compressible. Preferably, they are made of a cellular elastomer, especially polyurethane, by means of foaming.

Over the working width, there are several, identically designed braking rollers 19 at a distance from each other on the rotating axis 21 whose lamellae 22 end in a shared cylindrical enveloping surface, that is to say, they have the same radial position.

Due to the configuration of the braking rollers 19, a sheet 24 entering with its front sheet edge is braked since its kinetic energy is transferred to the lamellae 22. The elastic lamellae 22 are pressed towards the back and yield by deflecting. In this process, the deflection distance corresponds to the braking distance of a sheet 24. If a volume-compressible material is used for the lamellae 22, at the same time, part of the braking energy is converted into deformation energy. The effective circumferential speed of the braking roller 19 is reduced during the braking of a sheet 24 until it is approximately the same as the conveying speed of the lower, slower sheet 24 that is being transported lying flat on the lower conveyor belt 17. The braking is carried out so slowly that impact and thus marking of the front edge of the sheet is avoided.

The undercutting of the lamellae 22 at their end means that a following sheet 24 is pressed as late as possible against the slower sheet 24 that is underneath it. At the same time, the lamellae 22 press a sheet 24 downwards only slightly since the lamellae 22 bend and can thus yield. In comparison to the conventional process, during the pressing of the following sheet 24 onto the preceding sheet 24, only the relative speed that might still be present is braked. The pressing is done with just a small pressing force so that markings on the surfaces of the sheets are avoided. Since the braking roller 19 is rotating, the lamellae 22 bounce back after they have been lifted off the sheet 24.

1. A device for crosscutting webs of material, including crosscutting means comprising two blade drums fitted with transverse blades and having a sheet transport means positioned downstream from the crosscutting means, said sheet transport means comprising braking means with a braking roller wherein the braking roller comprises a cylindrical basic element defining a circumference on which radially projecting lamellae made of an elastic material are attached on the circumference formed at intervals from each other, said lamellae ending in a cylindrical enveloping surface that is coaxial with the basic element.

2. The device according to claim 1, wherein the lamellae are tilted by an angle relative to the radial.

3. The device according to claim 1 wherein the lamellae are formed by axial slits cut along the circumference of a hollow cylinder made of elastic material.

4. The device according to claim 1 wherein the lamellae are made of a cellular plastic material.

5. The device according to claim 4, wherein the lamellae are made of polyurethane.
